(19) United States
(12) Patent Application Publication
(10) Pub. No.: US 2020/0327344 A1
(43) Pub. Date: Oct. 15, 2020

(54) OCCUPANT DETECTION DEVICE

(71) Applicant: DENSO CORPORATION, Kariya-City (JP)

(72) Inventor: Hajime NAKAGAWA, Kariya-city (JP)

(21) Appl. No.: 16/915,637

(22) Filed: Jun. 29, 2020

Related U.S. Application Data
(63) Continuation of application No. PCT/JP2018/045845, filed on Dec. 13, 2018.

(30) Foreign Application Priority Data
Jan. 16, 2018 (JP) 2018-004883

(51) Int. Cl. G06K 9/00; B60R 11/04; G06K 9/20; H04N 5/225

(52) U.S. Cl. CPC G06K 9/00838; H04N 5/2253; G06K 9/2018; B60R 11/04

(57) ABSTRACT

An occupant detection device for a vehicle includes a first sensor and a second sensor. The first sensor is an image sensor that captures an image of an inside of a cabin of the vehicle, and is disposed at a front portion of the cabin in a longitudinal direction of the vehicle. The second sensor is provided to detect an occupant on a rear seat of the vehicle. The second sensor is arranged on a ceiling of the cabin behind a center of a seat surface of the rear seat in the longitudinal direction of the vehicle.

### CROSS REFERENCE TO RELATED APPLICATION

The present application is a continuation application of International Patent Application No. PCT/JP2018/045845 filed on Dec. 13, 2018, which designated the U.S. and claims the benefit of priority from Japanese Patent Application No. 2018-004883 filed on Jan. 16, 2018. The entire disclosures of all of the above applications are incorporated herein by reference.

### TECHNICAL FIELD

The present disclosure relates to an occupant detection device for a vehicle.

### BACKGROUND

An occupant detection device is configured to detect an occupant seated on each seat in a vehicle.

### SUMMARY

According to an aspect of the present disclosure, an occupant detection device for a vehicle includes: a first sensor disposed at a front portion of a cabin in a longitudinal direction of the vehicle, the first sensor being an image sensor configured to image an inside of the cabin; and a second sensor provided to detect an occupant on a rear seat in the cabin. The second sensor is disposed on a ceiling of the cabin at a position rearward of a center of a seat surface of the rear seat in the longitudinal direction of the vehicle.

### BRIEF DESCRIPTION OF DRAWINGS

FIG. 1 is a plan view illustrating a schematic configuration of a vehicle equipped with an occupant detection device according to a first embodiment.

FIG. 2 is a side view illustrating a schematic configuration of a vehicle equipped with the occupant detection device according to the first embodiment.

FIG. 3 is a flowchart illustrating an operation of the occupant detection device illustrated in FIGS. 1 and 2.

FIG. 4 is a plan view illustrating a schematic configuration of a vehicle equipped with an occupant detection device according to a second embodiment.

FIG. 5 is a side view illustrating a schematic configuration of a vehicle equipped with the occupant detection device according to the second embodiment.

FIG. 6 is a flowchart illustrating an operation of the occupant detection device illustrated in FIGS. 4 and 5.

FIG. 7 is a plan view illustrating a schematic configuration of a vehicle equipped with an occupant detection device according to a third embodiment.

FIG. 8 is a side view illustrating a schematic configuration of a vehicle equipped with the occupant detection device according to the third embodiment.

FIG. 9 is a flowchart illustrating an operation of the occupant detection device illustrated in FIGS. 7 and 8.

FIG. 10 is a plan view illustrating a schematic configuration of a vehicle equipped with an occupant detection device according to a modification.

### DESCRIPTION OF EMBODIMENTS

To begin with, examples of relevant techniques will be described.

An occupant detection device is configured to detect the presence or absence of an occupant on each seat of a vehicle. The occupant detection device includes a load sensor and/or an image sensor. For example, the occupant detection device detects the presence or absence of an occupant and a seating state of the occupant based on image data captured by a CCD camera.

For example, a weight of a child seat varies depending on the product, and ranges from less than 5 kg to about 15 kg. In this type of device using a load sensor, it was difficult to accurately detect the presence or absence of an infant seated on the child seat.

Further, the child seat includes a front-facing one and a rear-facing one. For a device using an image sensor such as a CCD camera, when a rear-facing child seat is mounted on the rear seat, it is difficult to accurately detect the presence or absence of an infant seated on the child seat.

The present disclosure provides an occupant detection device capable of accurately detecting whether or not a baby is seated on a child seat mounted on a rear seat.

According to an aspect of the present disclosure, an occupant detection device for a vehicle includes: a first sensor disposed at a front portion of a cabin in a longitudinal direction of the vehicle, the first sensor being an image sensor configured to image an inside of the cabin; and a second sensor provided to detect an occupant on a rear seat in the cabin. The second sensor is disposed on a ceiling of the cabin at a position rearward of a center of a seat surface of the rear seat in the longitudinal direction.

According to another aspect of the present disclosure, an occupant detection device for a vehicle includes: an image sensor disposed at a front portion of a cabin in a longitudinal direction of the vehicle to image an inside of the cabin; and a reflecting mirror disposed above a seat surface of a rear seat in a height direction of the vehicle. The reflecting mirror is disposed such that a reflected image of the rear seat viewed from an upper side is within an imaging range of the image sensor.

A reference numeral is attached to each element in this document to indicate merely an example in embodiments. The present disclosure is not limited to the embodiments by the reference numerals.

Hereinbelow, embodiments will be described with reference to the drawings. Note that various modifications applicable to one embodiment are collectively described after explanation of the embodiment because understanding of the embodiment may be interfered when inserted in the middle of a series of explanations related to the embodiment.

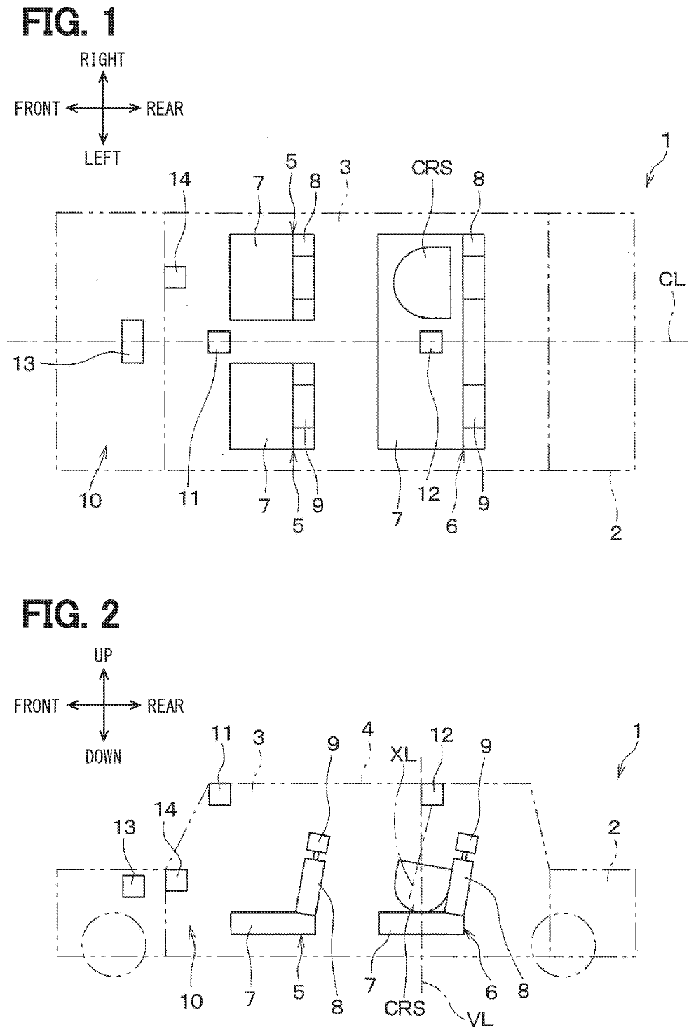

A schematic configuration of a vehicle 1 to which the present disclosure is applied will be described with reference to FIGS. 1 and 2. Referring to FIGS. 1 and 2, the vehicle 1 is a so-called automobile and has a box-shaped vehicle body 2.

Hereinafter, in the present specification, for convenience of description, the concepts of “front”, “rear”, “left”, “right”, “up” and “down” in the vehicle 1 and the vehicle body 2 will be described with reference to arrows in the drawings. The front-rear direction parallel to the vehicle center axis CL is referred to as “longitudinal direction” of the vehicle. The left-right direction perpendicular to the front-rear direction is referred to as “width direction” of the vehicle. The up-down direction perpendicular to the front-rear direction and the left-right direction is referred to as “height direction” of the vehicle. The height direction is substantially parallel to the gravity direction when the vehicle 1 is placed on a substantially horizontal ground.

A cabin 3 of the vehicle is a space inside the vehicle body 2 where an occupant can board, and the upper part of the cabin 3 is covered by a ceiling 4. A front seat 5 and a rear seat 6 are arranged in the cabin 3.

The front seat 5 is arranged in a front part of the cabin 3. The front seat 5 includes a driver seat and a passenger seat. The front seat 5 has a seat surface 7, a seat back 8, and a headrest 9. The seat back 8 extends upward and slightly backward from the seat surface 7. The headrest 9 is mounted on the upper end of the seat back 8.

The rear seat 6 is disposed behind the front seat 5 in the cabin 3. The rear seat 6, like the front seat 5, has a seat surface 7, a seat back 8, and a headrest 9. The rear seat 6 has a seat surface 7 formed in a rectangular shape having a longitudinal direction corresponding to the width direction, and is configured such that two or three occupants can be seated on the rear seat 6.

A child restraint system (CRS) can be attached to and detached from the rear seat 6 and the passenger seat of the front seat 5. The child seat CRS is fixed to face frontward or rearward. The “frontward facing” CRS is configured such that the baby faces forward when the child seat CRS is mounted. The “rearward facing” CRS is configured such that the baby faces rearward when the child seat CRS is mounted.

An occupant detection device 10 is mounted on the vehicle body 2. The occupant detection device 10 is configured to detect the presence or absence of an occupant on each seat of the vehicle 1.

### First Embodiment

Hereinafter, the configuration of the occupant detection device 10 according to the first embodiment will be described. The occupant detection device 10 includes a first sensor 11, a second sensor 12, a control unit 13, and an operation unit 14.

The first sensor 11 is an image sensor that captures an image of the interior of the cabin 3, and is disposed at a front portion of the cabin 3. In the present embodiment, the first sensor 11 is a CCD camera, and is arranged at the center of the cabin 3 in the width direction. Specifically, the first sensor 11 is provided on, for example, a rear view mirror (not shown) fixed to the front end of the ceiling 4.

The second sensor 12 is provided so as to detect an occupant on the rear seat 6. The second sensor 12 is disposed on the ceiling 4 behind the center of the seat surface 7 of the rear seat 6 in the longitudinal direction. That is, as shown in FIG. 2, the second sensor 12 is disposed on a rear side of a vertical line VL. The vertical line VL is an imaginary straight line that is parallel to the height direction and passes through the center of the seat surface 7 of the rear seat 6 in the longitudinal direction of the vehicle.

In the present embodiment, the second sensor 12 is an image sensor that captures an image of the inside of the cabin 3 and is provided so as to capture an occupant on the rear seat 6 from the upper side. Specifically, the second sensor 12 is a wide-angle CCD camera, and is disposed at the center of the cabin 3 in the width direction. That is, the second sensor 12 is provided such that the entirety of the seat surface 7 of the rear seat 6 in the width direction falls within the view range of the second sensor 12.

As shown in FIG. 2, the second sensor 12 is provided such that the optical axis XL crosses the seat surface 7 of the rear seat 6 while the optical axis XL extends forward in the longitudinal direction relative to the downward direction, in a side view. The optical axis XL is a virtual straight line extending from the second sensor 12 in the imaging direction so as to pass through the center of the field of view of the second sensor 12.

The control unit 13 is an in-vehicle microcomputer or ECU that controls the operation of the occupant detection device 10, and includes a CPU, a ROM, a RAM, and a nonvolatile RAM (not shown). ECU is an abbreviation of Electronic Control Unit. The non-volatile RAM is, for example, a flash ROM. The CPU, ROM, RAM, and nonvolatile RAM of the control unit 13 are hereinafter simply referred to as “CPU”, “ROM”, “RAM”, and “nonvolatile RAM”.

The control unit 13 is configured to realize various control operations by reading and executing a program from the ROM or the nonvolatile RAM by the CPU. Various data used when executing the program are stored in the ROM or the nonvolatile RAM in advance. The various data include, for example, initial values, lookup tables, maps, and the like.

The operation unit 14 is provided to execute various operations according to the presence or absence of the occupant determined by the control unit 13. The operation unit 14 is controlled by the control unit 13. For example, the occupant detection device 10 may be applied to an occupant protection system that protects an occupant of the vehicle 1 when an object (for example, another vehicle, a wall, a pole, or the like) existing outside the vehicle 1 collides with the vehicle 1. In this case, the operation unit 14 corresponds to an airbag mechanism and/or a belt pretensioner mechanism.

For example, the occupant detection device 10 may be applied to an occupant monitoring system. The occupant monitoring system is, for example, a system that recognizes the physical condition of the occupant seated on the rear seat 6 while the system makes the driver seated on the driver seat to concentrate on driving the vehicle 1. Alternatively, the occupant monitoring system is, for example, a system that prevents an infant from being left in the cabin 3. In this case, the operation unit 14 corresponds to an image display mechanism and/or an audio output mechanism.

Hereinafter, the outline of the operation according to the configuration of the present embodiment will be described together with the effects achieved by the configuration of the present embodiment.

The first sensor 11 captures an image of the interior of the cabin 3 rearward from the front and upper part of the cabin 3. Almost the entire upper body of the occupant seated on the front seat 5 is within the field of view of the first sensor 11. Therefore, the presence or absence of the occupant on the front seat 5 and the seating state are detected by the first sensor 11.

The first sensor 11 cannot view end portions of the seat surface 7 of the rear seat 6 in the width direction, due to the front seat 5 and the occupant seated on the front seat 5. In other words, blind spots of the first sensor 11 are located at the end portions of the seat surface 7 of the rear seat 6 in the width direction. However, the upper part of the seat back 8 and the central part of the rear seat 6 in the width direction can be visually recognized by the first sensor 11. Therefore, the presence or absence of the occupant on the rear seat 6 and the seating state can be detected when the occupant is an adult having a normal physique regardless of the seating position. Regarding the center portion of the rear seat 6 in the width direction, the presence or absence of the occupant and the seating state can be detected regardless of the physique of the occupant.

The second sensor 12 captures an image of the inside of the cabin 3 downward from the upper side of the rear seat 6. The entire rear seat 6 is within the field of view of the second sensor 12. Therefore, the presence or absence of the occupant on the rear seat 6 and the seating state are detected by the second sensor 12.

As shown in FIGS. 1 and 2, the rearward facing CRS is mounted on the rear seat 6 and an infant is seated on the child seat CRS. In this case, the infant on the child seat CRS is difficult to be visually recognized by an image sensor arranged on the front side of the child seat CRS. This is because the infant is hidden by the child seat CRS itself or by the front seat 5 and/or an occupant seated on the front seat 5.

According to the present embodiment, the second sensor 12 is disposed on the ceiling 4 of the cabin 3 behind the center of the seat surface 7 of the rear seat 6 in the longitudinal direction. Therefore, it is possible to accurately detect whether or not an infant is seated on the rearward facing CRS mounted on the rear seat 6.

In the present embodiment, the second sensor 12 is provided so that the optical axis XL intersects the seat surface 7 of the rear seat 6 and is oriented to face forward in the longitudinal direction relative to the downward direction in a side view. Therefore, the second sensor 12 can image the inside of the rearward facing CRS with an obliquely downward view line that faces slightly forward than downward. Thus, according to the present embodiment, it is possible to more accurately detect the presence or absence of an infant on the rearward facing CRS mounted on the rear seat 6.

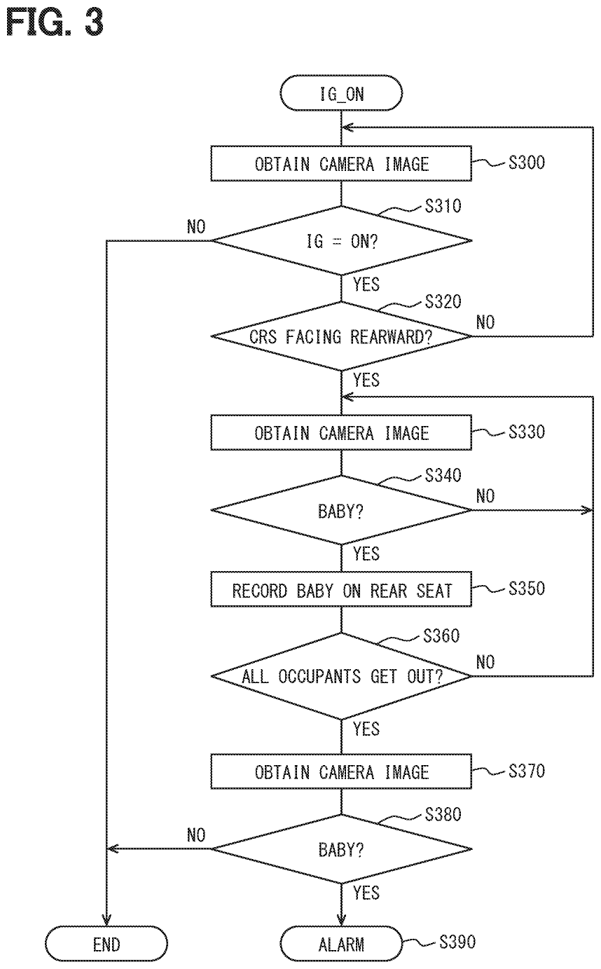

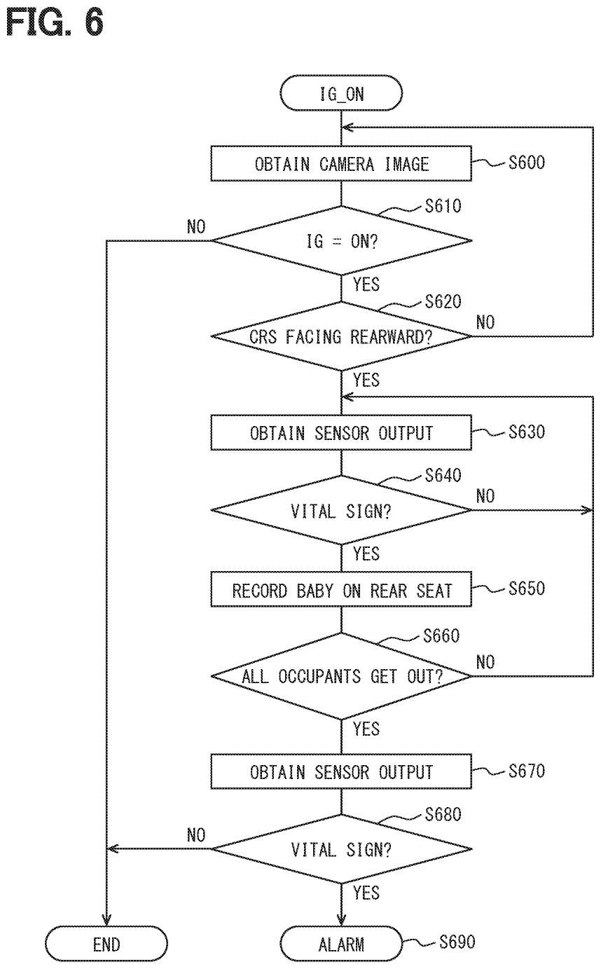

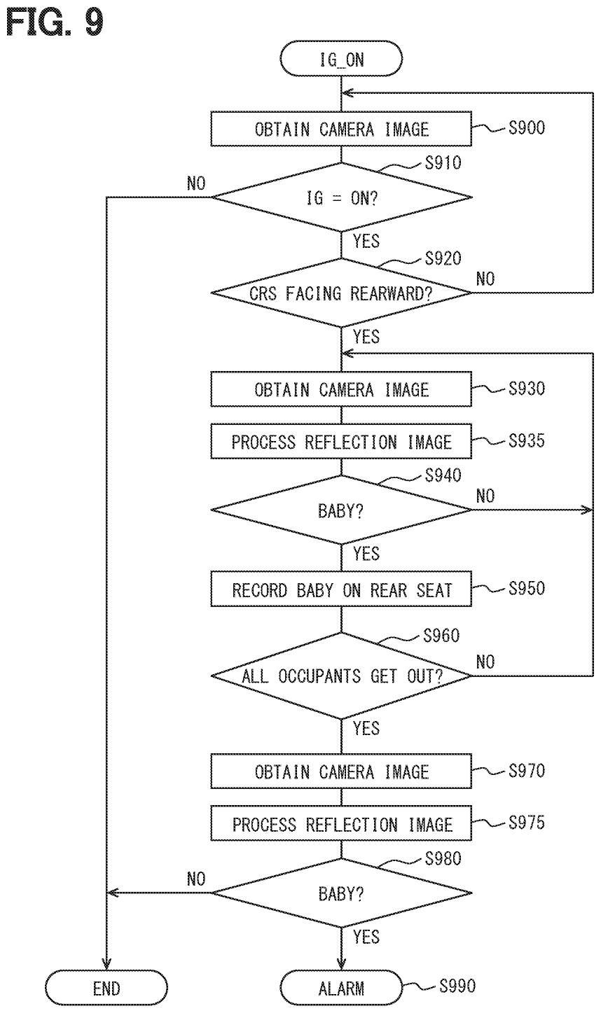

Hereinafter, an operation of the occupant detection device 10 according to the present embodiment will be described with reference to the flowchart of FIG. 3. In the drawings, “step” is abbreviated as “S”. The same applies to a second embodiment and a third embodiment described with reference to FIGS. 6 and 9.

In this embodiment, the occupant detection device 10 is applied to an occupant monitoring system. The same applies to the second embodiment and the third embodiment described later.

As shown in FIG. 3, the occupant detection device 10 is activated when an ignition switch of the vehicle 1 is turned on. When the occupant detection device 10 is activated, in S300, the occupant detection device 10 acquires a camera image. The camera image is a result of imaging by the first sensor 11 and the second sensor 12.

At S310, the occupant detection device 10 determines whether or not the ignition switch of the vehicle 1 remains on. When the ignition switch of the vehicle 1 is turned off (S310=NO), the occupant detection device 10 ends the operation. Hereinafter, the description of this operation is continued assuming that the ignition switch of the vehicle 1 is kept turned on (S310=YES).

If the determination in S310 is “YES”, the occupant detection device 10 causes the process to proceed to S320 and subsequent steps. At S320, the occupant detection device 10 determines whether or not the rearward facing CRS is mounted on the rear seat 6. The determination in S320 can be based on at least one of, for example, the camera image acquired in S300, the output of a load sensor (not shown) attached to the seat surface 7, the withdrawal amount of the seat belt, and the tension of the seat belt.

If the rearward facing CRS is not mounted on the rear seat 6 (S320=NO), the occupant detection device 10 returns the process to S300. When the rearward facing CRS is mounted on the rear seat 6 (S320=YES), the occupant detection device 10 causes the process to proceed to S330.

At S330, the occupant detection device 10 acquires a camera image again. Subsequently, in S340, the occupant detection device 10 determines whether or not a baby is present in the cabin 3 based on various information (for example, a camera image or the like) acquired so far.

If no baby is present in the cabin 3 (S340=NO), the occupant detection device 10 returns the process to S330. When a baby is present in the cabin 3 (S340=YES), the occupant detection device 10 causes the process to proceed to S350.

At S350, the occupant detection device 10 records that there is a baby on the rear seat 6. Subsequently, in S360, the occupant detection device 10 determines whether or not all the occupants have exited. The determination in S360 can be made based on, for example, information on opening and closing of the door of the vehicle 1 and the output of the load sensor.

When all the occupants have exited (S360=YES), the occupant detection device 10 causes the process to proceed to S370. When all the occupants have not completed getting out (S360=NO), the occupant detection device 10 returns the process to S330.

At S370, the occupant detection device 10 acquires a camera image again. Subsequently, in S380, the occupant detection device 10 determines whether or not a baby is present in the cabin 3 as in S340.

If there is no baby in the cabin 3 (S380=NO), the occupant detection device 10 ends the operation. When a baby is present in the cabin 3 (S380=YES), the occupant detection device 10 causes the process to proceed to S390. At S390, the occupant detection device 10 operates the operation unit 14 to output an alarm.

### Second Embodiment

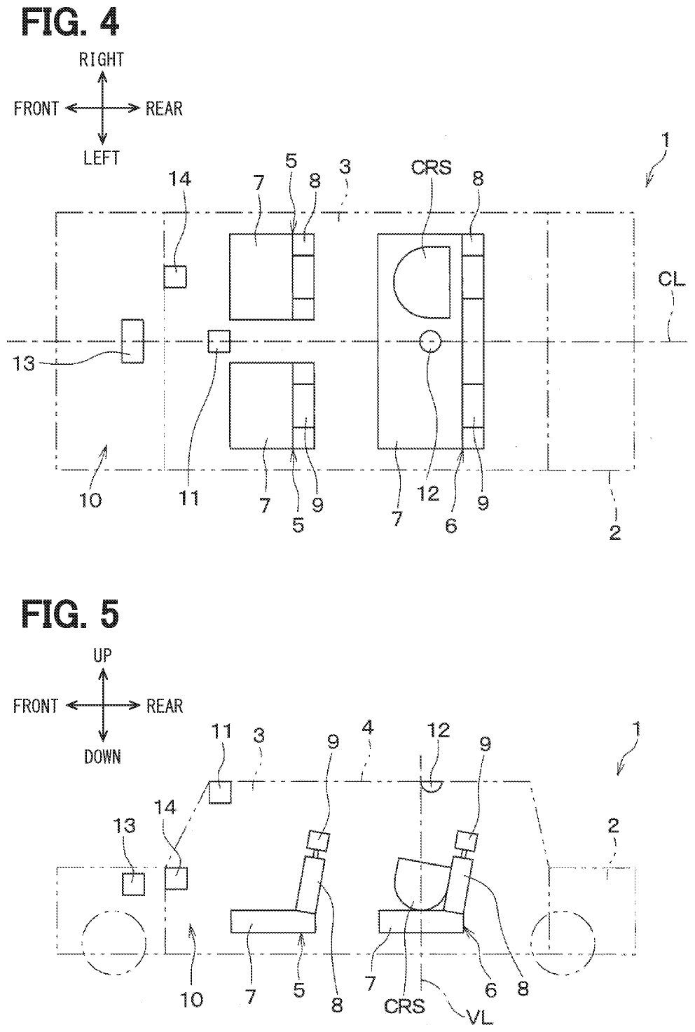

Hereinafter, the configuration of the occupant detection device 10 according to the second embodiment will be described with reference to FIGS. 4 and 5. In the following description of the second embodiment, only portions different from the first embodiment will be described. Further, the same reference numerals are given to the same or equivalent parts between the first embodiment and the second embodiment. Therefore, in the following description of the second embodiment, as for components having the same reference numerals as those in the first embodiment, the description in the first embodiment can be appropriately used unless there is a technical contradiction or a special additional description. The same applies to a third embodiment described later.

In the present embodiment, the second sensor 12 is an electromagnetic wave sensor that detects electromagnetic waves other than visible light, and is disposed on the ceiling 4 above the rear seat 6. Specifically, the second sensor 12 may be an ultrasonic sensor, a millimeter wave sensor, an infrared sensor, or the like.

The second sensor 12 is provided to detect the presence or absence of the occupant and the seating state over the entire seat surface 7 of the rear seat 6 in the width direction. Further, as shown in FIG. 5, the second sensor 12 is disposed behind the center of the seat surface 7 of the rear seat 6 in the longitudinal direction.

Hereinafter, the outline of the operation according to the configuration of the present embodiment will be described together with the effects achieved by the configuration of the present embodiment.

The first sensor 11 captures an image of the interior of the cabin 3 rearward from the front and upper part of the cabin 3. Thereby, the presence or absence of the occupant on the front seat 5 and the seating state are detected. In addition, the first sensor 11 detects the presence or absence of an adult having a normal physique on the rear seat 6 and the seating state. Further, regardless of the physique of the occupant, the first sensor 11 detects the presence or absence of an occupant at the central portion of the rear seat 6 in the width direction and the seating state.

The second sensor 12 detects the presence or absence of an occupant on the rear seat 6 and the seating state from the upper side of the rear seat 6. Accordingly, it is possible to accurately detect whether or not a baby is seated on the rearward facing CRS mounted on the rear seat 6.

In the first embodiment, the second sensor 12 is also an image sensor, like the first sensor 11. That is, in the first embodiment, two image sensors are used.

In the present embodiment, the image sensor is only the first sensor 11. Therefore, an inexpensive sensor different from the image sensor can be used as the second sensor 12. Accordingly, the cost of the occupant detection device 10 can be reduced.

Hereinafter, an operation of the occupant detection device 10 according to the present embodiment will be described with reference to the flowchart in FIG. 6.

As shown in FIG. 6, the occupant detection device 10 is activated when an ignition switch of the vehicle 1 is turned on. When the occupant detection device 10 is activated, in S600, the occupant detection device 10 acquires a camera image. The camera image is a result of imaging by the first sensor 11.

At S610, the occupant detection device 10 determines whether or not the ignition switch of the vehicle 1 is kept on. When the ignition switch of vehicle 1 is turned off (S610=NO), the occupant detection device 10 ends the operation. Hereinafter, the description of this operation is continued assuming that the ignition switch of the vehicle 1 is kept ON (S610=YES).

If the determination in S610 is “YES”, the occupant detection device 10 causes the process to proceed to S620 and subsequent steps. At S620, the occupant detection device 10 determines whether or not the rearward facing CRS is mounted on the rear seat 6.

If the rearward facing CRS is not mounted on the rear seat 6 (S620=NO), the occupant detection device 10 returns the process to S600. When the rearward facing CRS is attached to the rear seat 6 (S620=YES), the occupant detection device 10 causes the process to proceed to S630.

At S630, the occupant detection device 10 acquires an output of the second sensor 12. Subsequently, at S640, the occupant detection device 10 determines whether or not the rearward facing CRS has a vital sign based on the output of the second sensor 12. The “vital sign” is a sign indicating that a living body exists.

If there is no vital sign (S640=NO), the occupant detection device 10 returns to S630 assuming that there is no baby in the cabin 3. When there is a vital sign (S640=YES), the occupant detection device 10 proceeds to S650 assuming that a baby is present in the cabin 3.

At S650, the occupant detection device 10 records that there is a baby on the rear seat 6. Subsequently, in S660, the occupant detection device 10 determines whether or not all occupants have exited.

When all the occupants have completed getting out (S660=YES), the occupant detection device 10 causes the process to proceed to S670. If all the occupants have not completed getting out (S660=NO), the occupant detection device 10 returns the process to S630.

At S670, the occupant detection device 10 obtains an output of the second sensor 12 again. Subsequently, in S680, the occupant detection device 10 determines whether or not there is a vital sign in the rearward facing CRS, as in S640.

If there is no vital sign (S680=NO), the occupant detection device 10 ends the operation assuming that there is no baby in the cabin 3. When there is a vital sign (S680=YES), the occupant detection device 10 proceeds to S690 assuming that a baby is present in the cabin 3. In S690, the occupant detection device 10 operates the operation unit 14 to output an alarm.

### Third Embodiment

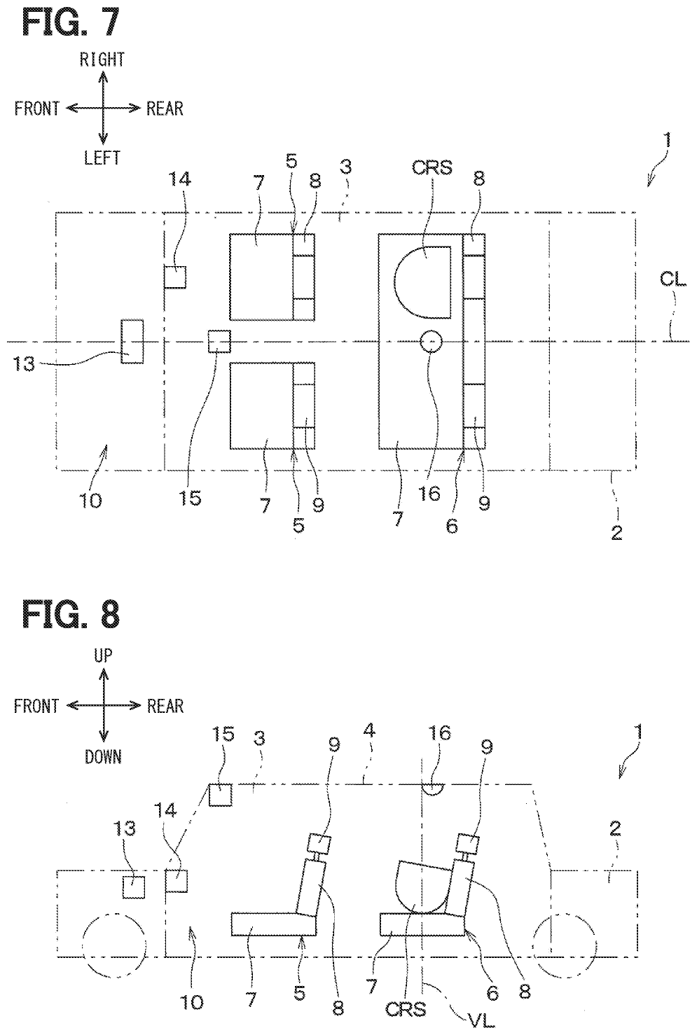

Hereinafter, the configuration of the occupant detection device 10 according to the third embodiment will be described with reference to FIGS. 7 and 8.

The occupant detection device 10 according to the present embodiment includes an image sensor 15 similar to the first sensor 11, and a reflecting mirror 16 provided in place of the second sensor 12. Otherwise, the occupant detection device 10 according to the present embodiment has the same configuration as each of the above embodiments.

The image sensor 15 is disposed at the front portion of the cabin 3 in the longitudinal direction so as to capture an image of the interior of the cabin 3 of the vehicle 1. The reflecting mirror 16 is arranged above the seat surface 7 of the rear seat 6 in the height direction. The image sensor 15 and the reflecting mirror 16 are arranged at the center of the cabin 3 in the width direction.

The reflecting mirror 16 is disposed on the ceiling 4 of the cabin 3 behind the center of the seat surface 7 of the rear seat 6 in the longitudinal direction. The reflecting mirror 16 is a convex mirror having a substantially hemispherical mirror surface protruding downward, and is arranged so that a reflection image of an image of the rear seat 6 viewed from the upper side is within an imaging range of the image sensor 15.

Hereinafter, the outline of the operation according to the configuration of the present embodiment will be described together with the effects achieved by the configuration of the present embodiment.

The image sensor 15 captures an image of the inside of the cabin 3 rearward from the front and upper part of the cabin 3. Thereby, the presence or absence of the occupant on the front seat 5 and the seating state are detected. In addition, the image sensor 15 detects the presence or absence of an adult having a normal physique on the rear seat 6 and the seating state. Further, regardless of the physique of the occupant, the presence or absence of the occupant at the central portion of the rear seat 6 in the width direction and the seating state are detected.

An image of a portion of the rear seat 6 that cannot be detected by the image sensor 15 is reflected on the reflecting mirror 16 existing in the field of view of the image sensor 15. The view area of the image sensor 15 can be set in advance corresponding to the mirror surface of the reflecting mirror 16 on which such an image is reflected.

Therefore, an image of the rear seat 6 viewed from the upper side is acquired by performing appropriate image processing (for example, enlargement, mirror image processing, and the like) on the view area of the image sensor 15 that is set in advance corresponding to the mirror surface of the reflecting mirror 16. The presence or absence of the occupant on the rear seat 6 and the seating state are detected based on the image acquired in this manner.

In the present embodiment, the reflecting mirror 16 is disposed on the ceiling 4 of the cabin 3 behind the center of the seat surface 7 of the rear seat 6 in the longitudinal direction. For this reason, even when the rearward facing CRS is mounted on the rear seat 6, an image of the inside of the rearward facing CRS is reflected by the reflecting mirror 16 and is captured by the image sensor 15. Therefore, it is possible to accurately detect whether or not a baby is seated on the rearward facing CRS mounted on the rear seat 6.

In the first embodiment, the second sensor 12 is also an image sensor, like the first sensor 11. That is, in the first embodiment, two image sensors are used. In the second embodiment, a sensor capable of detecting vital signs is used as the second sensor 12. That is, in the first and second embodiments, two sensors are used.

In contrast, in the present embodiment, only the image sensor 15 is used as a sensor for directly detecting an occupant, and a reflecting mirror 16 is used instead of the second sensor 12. Therefore, the cost of the occupant detection device 10 can be further reduced.

Hereinafter, an operation of the occupant detection device 10 according to the present embodiment will be described with reference to the flowchart in FIG. 9.

As shown in FIG. 9, the occupant detection device 10 is activated when an ignition switch of the vehicle 1 is turned on. When the occupant detection device 10 is activated, in S900, the occupant detection device 10 acquires a camera image. The camera image is a result of imaging by the first sensor 11.

In S910, the occupant detection device 10 determines whether or not the ignition switch of the vehicle 1 remains on. When the ignition switch of vehicle 1 is turned off (S910=NO), the occupant detection device 10 ends the operation. Hereinafter, the description of the operation is continued assuming that the ignition switch of the vehicle 1 is kept on (S910=YES).

If the determination in S910 is “YES”, the occupant detection device 10 causes the process to proceed to S920 and subsequent steps. At S920, the occupant detection device 10 determines whether or not the rearward facing CRS is mounted on the rear seat 6.

If the rearward facing CRS is not mounted on the rear seat 6 (S920=NO), the occupant detection device 10 returns the process to S900. When the rearward facing CRS is attached to the rear seat 6 (S920=YES), the occupant detection device 10 causes the process to proceed to S930.

At S930, the occupant detection device 10 acquires a camera image again. Subsequently, in S935, the occupant detection device 10 performs appropriate image processing (enlargement, mirror image processing, and the like) relative to an area preset in correspondence with the mirror surface of the reflecting mirror 16, in the camera image acquired in S930. Thereafter, in S940, the occupant detection device 10 determines whether or not a baby is present in the cabin 3 based on the image processing result in S935 and the like.

If no baby is present in the cabin 3 (S940=NO), the occupant detection device 10 returns the process to S930. When there is a baby in the cabin 3 (S940=YES), the occupant detection device 10 causes the process to proceed to S950.

At S950, the occupant detection device 10 records that there is a baby on the rear seat 6. Subsequently, in S960, the occupant detection device 10 determines whether or not all the occupants have exited.

When all the occupants have exited (S960=YES), the occupant detection device 10 causes the process to proceed to S970. If all the occupants have not completed getting out (S960=NO), the occupant detection device 10 returns the process to S930.

At S970, the occupant detection device 10 acquires a camera image again. Further, in S975, the occupant detection device 10 performs the same image processing as in S935 on a region of the camera image acquired in S970 that is set in advance corresponding to the mirror surface of the reflecting mirror 16. In S980, the occupant detection device 10 determines whether or not a baby is present in the cabin 3 as in S940.

If no baby is present in the cabin 3 (S980=NO), the occupant detection device 10 ends the operation. When a baby is present in the cabin 3 (S980=YES), the occupant detection device 10 causes the process to proceed to S990. In S990, the occupant detection device 10 operates the operation unit 14 to output an alarm.

### (Modification)

The present disclosure is not limited to the above embodiment. The above embodiment can be appropriately changed. Hereinbelow, representative modifications will be described. In the following description of modifications, only parts different from the above-described embodiment will be described. In addition, in the above-described embodiment and the modifications, the same reference numerals are given to the same or equivalent parts. Therefore, in the description of the following modifications, regarding components having the same reference numerals as the components of the above-described embodiment, the description in the above-described embodiment can be appropriately cited unless there is a technical inconsistency or a specific additional explanation.

The present disclosure is not limited to the specific device configuration shown in the above embodiment. For example, the front seat 5 may be a so-called “bench seat” in which a driver seat and a passenger seat are integrated. Alternatively, for example, the rear seat 6 may be divided for each occupant, similarly to the front seat 5.

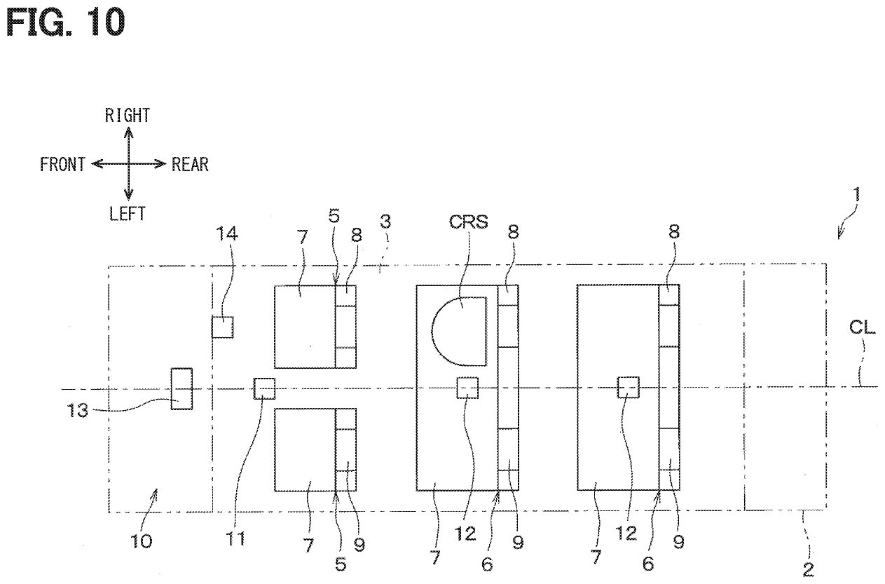

The number of the rear seat 6 in the vehicle 1 is not limited to one row. That is, the present disclosure can be suitably applied to the vehicle 1 having plural rear seats 6 (for example, two rows). In this case, the second sensor 12 may be preferably provided corresponding to each row of the rear seats 6, as shown in FIG. 10. The same applies to the reflecting mirror 16.

The number and arrangement of the first sensor 11 and the second sensor 12 are not limited to the above embodiment. The same applies to the image sensor 15 and the reflecting mirror 16.

The first sensor 11, the second sensor 12, and the image sensor 15 may be an infrared camera. An infrared camera may be referred to as an “image sensor” or may be referred to as an “electromagnetic wave sensor”.

The constituent element(s) of each of the above embodiments is/are not necessarily essential unless it is specifically stated that the constituent element(s) is/are essential in the above embodiments, or unless the constituent element(s) is/are obviously essential in principle. In addition, in the case where the number of the constituent element(s), the value, the amount, the range, and/or the like is specified, the present disclosure is not necessarily limited to the number of the constituent element(s), the value, the amount, and/or the like specified in the embodiment unless the number of the constituent element(s), the value, the amount, and/or the like is indicated as essential or is obviously essential in view of the principle. Similarly, in the case where the shape, the direction, the positional relationship, and/or the like of the constituent element(s) is specified, the present disclosure is not necessarily limited to the shape, the direction, the positional relationship, and/or the like unless the shape, the direction, the positional relationship, and/or the like is/are indicated as essential or is/are obviously essential in principle.

The modifications are also not limited to the above examples. The modifications may be combined with each other. Furthermore, all or a part of the above-described embodiments and all or a part of the modifications may be combined with each other.

What is claimed is:

1. An occupant detection device for a vehicle comprising:
a first sensor disposed at a front portion of a cabin in a longitudinal direction of the vehicle, the first sensor being an image sensor configured to image an inside of the cabin; and
a second sensor provided to detect an occupant on a rear seat in the cabin, wherein
the second sensor is disposed on a ceiling of the cabin at a position rearward of a center of a seat surface of the rear seat in the longitudinal direction.

2. The occupant detection device according to claim 1, wherein the first sensor and the second sensor are disposed at a center of the cabin in a width direction of the vehicle.

3. The occupant detection device according to claim 1, wherein
the second sensor includes an image sensor configured to image an inside of the cabin, and
the second sensor has an optical axis extending in an imaging direction and intersecting with the seat surface of the rear seat, and
the optical axis is directed forward in the longitudinal direction relative to a height direction of the vehicle parallel to a downward direction.

4. The occupant detection device according to claim 1, wherein the second sensor includes an electromagnetic wave sensor that detects electromagnetic waves other than visible light.

5. An occupant detection device for a vehicle comprising:
an image sensor disposed at a front portion of a cabin in a longitudinal direction of the vehicle to image an inside of the cabin; and
a reflecting mirror disposed above a seat surface of a rear seat in a height direction of the vehicle, wherein
the reflecting mirror is disposed such that a reflected image of an image of the rear seat viewed from an upper side is within an imaging range of the image sensor.

6. The occupant detection device according to claim 5, wherein the reflecting mirror is disposed on a ceiling of the cabin behind a center of the seat surface of the rear seat in the longitudinal direction of the vehicle.

7. The occupant detection device according to claim 5, wherein the image sensor and the reflecting mirror are disposed at a center in the cabin in a width direction of the vehicle.
